(19) United States
(12) Patent Application Publication
(10) Pub. No.: US 2026/0268573 A1
(43) Pub. Date: Sep. 10, 2026

(54) METHOD FOR ANIMATION DEVELOPMENT AND RELATED PRODUCTS THEREOF

(71) Applicants: Nanjing Xiyin Ecommerce Co., Ltd., Jiangsu (CN); Guangzhou Xiyin International Import and Export Co., Ltd., Guangdong (CN); Shenzhen Xiyin Information Technology Co., Ltd., Guangdong (CN)

(72) Inventor: MIAO LIU, Jiangsu (CN)

(21) Appl. No.: 19/311,168

(22) Filed: Aug. 27, 2025

(30) Foreign Application Priority Data
Mar. 7, 2025 (CN) 2025102725314

(51) Int. Cl. G06T 13/80; G06F 40/109; G06F 40/205; G06T 3/40

(52) U.S. Cl. CPC G06T 13/80; G06F 40/109; G06F 40/205; G06T 3/40

(57) ABSTRACT

A method for animation development includes acquiring an animation description file, loading and parsing the animation description file by a preview tool to display an animation effect corresponding to the animation description file on a preview playback interface of the preview tool, where the preview playback interface includes a configuration panel, receiving a configuration item set by a user based on the configuration panel, and adjusting the animation effect in real time according to the configuration item, and receiving a user confirmation instruction, and generating, according to the configuration item, a target animation description file and/or a target animation code file corresponding to the adjusted animation effect.

### CROSS-REFERENCE TO RELATED APPLICATION AND CLAIM OF PRIORITY

This application claims the benefit under 35 USC § 119 of Chinese Patent Application No. 2025102725314, filed on Mar. 7, 2025, in the China Intellectual Property Office, the entire disclosure of which is incorporated herein by reference for all purposes.

### BACKGROUND

### 1. Technical Field

The present disclosure generally relates to the technical field of animation development. More specifically, the present disclosure relates to a method and a processing apparatus for animation development, and a non-transitory machine-readable medium.

### 2. Background Art

In the core business scenarios of user growth, there is a substantial demand for animated interactive designs. Given the rapidly changing market environment and user preferences, interactive animations have to be iterated at an extremely high frequency to ensure continuous attraction to new users, enhance user stickiness, and drive sustained business growth. In the past, interactive animation designs greatly depends on CSS (Cascading Style Sheets) for implementation. While this approach provides basic dynamic effects to webpages, its limitations have become increasingly apparent.

First, the process of creating and adjusting CSS animations is often time-consuming, particularly when pursuing complex animation effects, which significantly extends the development cycle. Second, due to varying levels of CSS support across different browsers, developers have to spend additional time and effort in compatibility testing and repair to ensure consistent rendering of the animation effect across different devices. This undoubtedly increases development costs.

Therefore, there is an urgent need for a method for animation development which can enable more effective animation development.

### SUMMARY

To address at least one or more of the above technical problems, the present disclosure proposes, in various aspects, a method for animation development, which can overcome at least one of the defects mentioned in the background art.

In a first aspect, the present disclosure provides a method for animation development, including: acquiring an animation description file; loading and parsing the animation description file by a preview tool to display an animation effect corresponding to the animation description file on a preview playback interface of the preview tool, where the preview playback interface includes a configuration panel; receiving a configuration item set by a user via the configuration panel and adjusting the animation effect in real time according to the configuration item; and receiving a user confirmation instruction to generate a target animation description file and/or a target animation code file corresponding to the adjusted animation effect based on the configuration item.

In some embodiments, the preview tool is implemented based on Lottie-web.

In some embodiments, loading and parsing the animation description file by the preview tool to display the animation effect corresponding to the animation description file on the preview playback interface of the preview tool includes: loading and parsing the animation description file by the preview tool to acquire an animation code file corresponding to the animation description file, wherein the preview tool loads the animation description file in an asynchronous loading mode; and rendering the animation code file to display the corresponding animation effect on the preview playback interface.

In some embodiments, receiving the configuration item set by the user via the configuration panel and adjusting the animation effect in real time according to the configuration item includes: upon receiving a first preset configuration item, performing font adaptive scaling on an animation text; and adjusting a vertical centering position of the text based on a line height and a text box height of the animation text after the font adaptive scaling, and then rendering the text to the preview playback interface.

In some embodiments, receiving the configuration item set by the user via the configuration panel and adjusting the animation effect in real time according to the configuration item includes: upon receiving a second preset configuration item, acquiring an html fragment corresponding to the second preset configuration item and an associated animation attributes, wherein the html fragment is imported by a user via the configuration panel; and synchronously injecting the html fragment and the animation attributes into corresponding positions in the animation code file and rendering them to the preview playback interface.

In some embodiments, receiving the configuration item set by the user via the configuration panel and adjusting the animation effect in real time according to the configuration item includes: upon receiving a third preset configuration item, acquiring style data corresponding to the third preset configuration item, wherein the style data is input by a user via the configuration panel, and the style data includes styles for a plurality of paragraphs in the text; and rendering the style data to text elements of the corresponding paragraph.

In some embodiments, after rendering the style data to text elements of the corresponding paragraph, the method includes: if a total character width of a text line exceeds a text box width, determining a scaling ratio according to a maximum font size within the text line; and scaling characters in the text line by the scaling ratio and cycling this process until the total character width of the text line is less than the text box width.

In some embodiments, receiving the configuration item set by the user via the configuration panel and adjusting the animation effect in real time according to the configuration item includes: upon receiving a fourth preset configuration item, mirroring the animation text; and identifying target elements within the animation text that should not be mirrored, and mirroring these target elements again to revert them.

In a second aspect, the present disclosure provides a processing apparatus for animation development, including: a processor configured to execute program instructions; and a memory configured to store the program instructions which, when loaded and executed by the processor, cause the processor to perform the method for animation development in the first aspect of the present disclosure.

In a third aspect, the present disclosure provides a non-transitory machine-readable medium having program instructions stored thereon which, when loaded and executed by a processor, cause the processor to perform the method for animation development in the first aspect of the present disclosure.

According to the method for animation development provided above, embodiments of the present disclosure can load and parse the animation description file by a preview tool to display an animation effect corresponding to the animation description file on a preview playback interface of the preview tool, thereby implementing animation playback. Further, by providing a configuration panel including various configuration items on the preview playback interface, a developer can adjust the animation effect by simply setting the configuration items and inputting related information, and a target animation description file and/or a target animation code file corresponding to the adjusted animation effect can be generated according to the configuration items without manual modification of the animation code by the developer, thereby achieving the effect of improving the animation development efficiency.

### BRIEF DESCRIPTION OF THE DRAWINGS

The above and other objectives, features and advantages of the exemplary implementations of the present disclosure will become readily apparent from the following detailed description, which proceeds with reference to the accompanying drawings. In the accompanying drawings, several implementations of the present disclosure are illustrated by way of example but not limitation, and like or corresponding reference numerals indicate like or corresponding parts, in which:

FIG. 1 shows an exemplary flowchart of a method for animation development according to an embodiment of the present disclosure;

FIG. 2 shows an exemplary flowchart of a method for animation development according to an embodiment of the present disclosure;

FIG. 3 shows an exemplary flowchart of a method for animation development according to an embodiment of the present disclosure;

FIG. 4 shows an exemplary flowchart of a method for animation development according to an embodiment of the present disclosure;

FIG. 5 shows an exemplary flowchart of a method for animation development according to an embodiment of the present disclosure; and

FIG. 6 shows an exemplary block diagram of an electronic device according to an embodiment of the present disclosure.

### DETAILED DESCRIPTION

The technical solutions in the embodiments of the present disclosure will be clearly and completely described below with reference to the accompanying drawings in the embodiments of the present disclosure. Apparently, the described embodiments are only part, but not all, of the embodiments of the present disclosure. All other embodiments, which can be derived by those skilled in the art from the embodiments of the present disclosure without making any creative effort, shall fall within the protection scope of the present disclosure.

It will be understood that the terms “comprise” and “include”, when used in the description and claims of the present disclosure, specify the presence of the stated features, integers, steps, operations, elements, and/or components, but do not preclude the presence or addition of one or more other features, integers, steps, operations, elements, components, and/or groups thereof.

It is also to be understood that the terminology used in the description of the disclosure herein is for the purpose of describing particular embodiments only, and is not intended to be limiting of the disclosure. As used in the specification and claims of the disclosure, the singular forms “a”, “an” and “the” are intended to include the plural forms as well, unless the context clearly indicates otherwise. It should be further understood that the term “and/or” as used in the description and claims of the disclosure refers to any and all possible combinations of one or more of the associated listed items and includes such combinations.

As used in this specification and claims, the term “if” may be interpreted as “when” or “once” or “in response to determining” or “in response to detecting” depending on the context. Similarly, the phrase “if it is determined” or “if [the described condition or event] is detected” may be interpreted contextually as meaning “upon determining” or “in response to determining” or “upon detecting [the described condition or event]” or “in response to detecting [the described condition or event]”.

Specific implementations of the present disclosure will be described in detail below with reference to the accompanying drawings.

### Exemplary Application Scenarios

Interactive animations are widely applied in business scenarios with growing users to improve user experience, enhance user stickiness, and facilitate user conversion. These scenarios typically cover an entire process from the first contact of a user with an application or website, to deep use and possibly conversion to a faithful user. Due to rapid changes in the market environment, continuous evolution of user preferences and continuous optimization of product functions, the animation interaction not only faces diversified demands, but also experiences an extremely high iteration frequency.

In some existing solutions, the implementation of interactive animations generally relies on CSS. However, the interactive animation development with CSS has some defects. First, the development cost of CSS is relatively high, especially when constructing a complex animation, as it requires writing a large amount of style codes, which increases the difficulty of development and maintenance. Second, although CSS provides rich animation effects, its visual fidelity may not fully meet expectations of designers in some complex scenarios or fine designs, resulting in a gap between the actual animation effects and the intended design.

### Exemplary Application Schemes

In view of this, an embodiment of the present disclosure provides a method for animation development, which optimizes the animation effect by adjusting configuration items of a preview tool, and can automatically generate an animation code file that can be directly copied into a project for use, thereby enabling an interactive animation to have higher development efficiency and adapt to various scenarios.

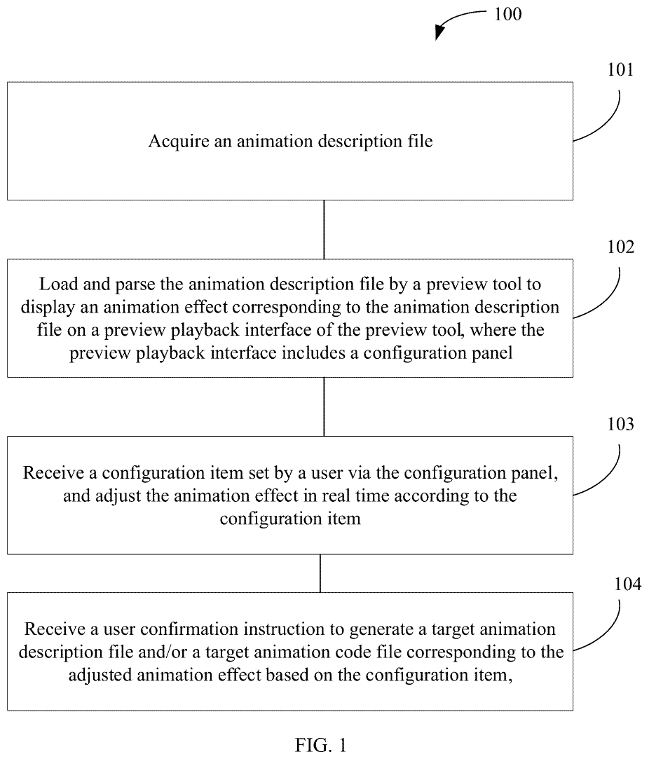

FIG. 1 shows an exemplary flowchart of a method 100 for animation development according to some embodiments of the present disclosure. As shown in FIG. 1, in step S101, the method 100 includes acquiring an animation description file. The animation description file is a file for storing and defining animation contents. Based on such a file, a developer can define a presentation manner of an animation, changes of the animation at different times and in different spaces, or an interaction mode with user actions. It will be appreciated that the animation description file cannot be directly played, and can be played only after the data stored in the animation description file is loaded and parsed and an animation effect is rendered.

In some embodiments, the animation description file may be obtained by a person, such as an animator, using animation design software to design an animation effect according to the requirements. For example, an animator may produce an animation according to the animation effect requirements in software adobe after effects (AE), and export an animation description file through a plugin bodymovin after the animation production is completed.

In some embodiments, the animation description file may be in a JSON format.

The process then proceeds to step S102, where the method 100 includes loading and parsing the animation description file by a preview tool to display an animation effect corresponding to the animation description file on a preview playback interface of the preview tool, where the preview playback interface includes a configuration panel.

In this embodiment, the preview tool is implemented based on Lottie-web. Lottie-web is an open source JavaScript library intended to help developers render and present Lottie animations on webpages. The Lottie-web library may read information of the animation description file in the JSON format to render a smooth animation on a webpage. Specifically, this embodiment makes improvements on the basis of Lottie-web to obtain a preview tool. It will be appreciated that the preview tool may be obtained by installing a Lottie-web library, taking advantage of functions provided by the Lottie-web library and making corresponding improvements. The corresponding method steps implemented by adopting the functions provided by the Lottie-web library are not described in detail in the embodiments of the disclosure, and only the optimization and improvement based on Lottie-web are specifically described, so that a person skilled in the art can refer to official documents or specifications of the Lottie-web library to obtain more specific information about use of the library.

Specifically, as a specific implementation of step S102, the animation description file may be loaded and parsed by a preview tool to acquire an animation code file corresponding to the animation description file. Then the animation code file is rendered to display a corresponding animation effect on the preview playback interface. In this embodiment, the loading mode of Lottie-Web is changed from synchronous loading to asynchronous loading, so that the animation description file is loaded by the preview tool in an asynchronous loading mode, thereby improving the loading speed of the webpage first screen by about 100 milliseconds.

It will be appreciated that the synchronous loading of Lottie-Web means that tasks are executed one by one in sequence, and a next task is executed continuously only when a current task is completed, resulting in a low loading speed. When the synchronous loading of Lottie-Web is changed to asynchronous loading, a plurality of tasks can be executed simultaneously, thereby increasing the webpage loading speed.

Further, the preview tool of this embodiment is implemented based on Lottie-web so that the preview playback interface of this embodiment can create a svg canvas for rendering the animation code file based on Lottie-web to present the corresponding animation effect. Specifically, svg is a vector graphics format which can accurately describe graphics shapes and details. In the Lottie-web rendering process, animation data is converted into a series of svg elements to ensure a high-quality, scalable and high-definition animation effect in the webpage. The method is particularly suitable for displaying the animation on different devices and screens without distortion due to size changes, thereby ensuring visual consistency of the animation at various resolutions.

In some embodiments, words of the animation text may be rendered in a svg single character rendering mode.

The process then proceeds to step S103, where the method 100 includes receiving a configuration item set by a user via the configuration panel, and adjusting the animation effect in real time according to the configuration item. The configuration panel is provided with a plurality of configuration items for performing different adjustments on the animation effect so that a developer can adjust the animation effect simply by selecting a corresponding configuration item and/or inputting the corresponding configuration content into the configuration item, and the adjusted animation effect can be viewed in real time on the preview playback interface, thereby saving manual modification of the animation code file by the developer and improving the animation development efficiency.

Finally, the process proceeds to step S104, where the method 100 includes receiving a user confirmation instruction to generate a target animation description file and/or a target animation code file corresponding to the adjusted animation effect based on the configuration item. In some embodiments, when a developer sets the configuration item and determines that the adjusted animation effect meets the requirement by viewing the animation through the preview playback interface, the preview tool may receive a user confirmation instruction by triggering, for example, a button or link for generating a target animation description file and/or a target animation code file on the preview playback interface, so as to generate the target animation description file and/or the target animation code file corresponding to the adjusted animation effect based on the configuration item set by the developer, thereby implementing animation development. The developer may export the target animation description file and/or the target animation code file, which are then directly copied into the corresponding project for use.

Generally, the method 100 for animation development of the present disclosure is described above with reference to FIG. 1. As can see, in embodiments of the present disclosure, the animation description file can be loaded and parsed by a preview tool to display an animation effect corresponding to the animation description file on a preview playback interface of the preview tool, thereby implementing animation playback. Further, by providing a configuration panel including various configuration items on a preview playback interface, a developer can adjust the animation effect by simply setting the configuration items and inputting related information, and a target animation description file and/or a target animation code file corresponding to the adjusted animation effect can be generated according to the configuration items without manual modification of the animation code by the developer, thereby achieving the effect of improving the animation development efficiency.

However, it should be understood by those skilled in the art that the method illustrated in FIG. 1 is exemplary and not limiting, and that those skilled in the art may make adjustments as needed. Various embodiments of the method 100 according to some embodiments of the present disclosure and variations thereof will be further described below.

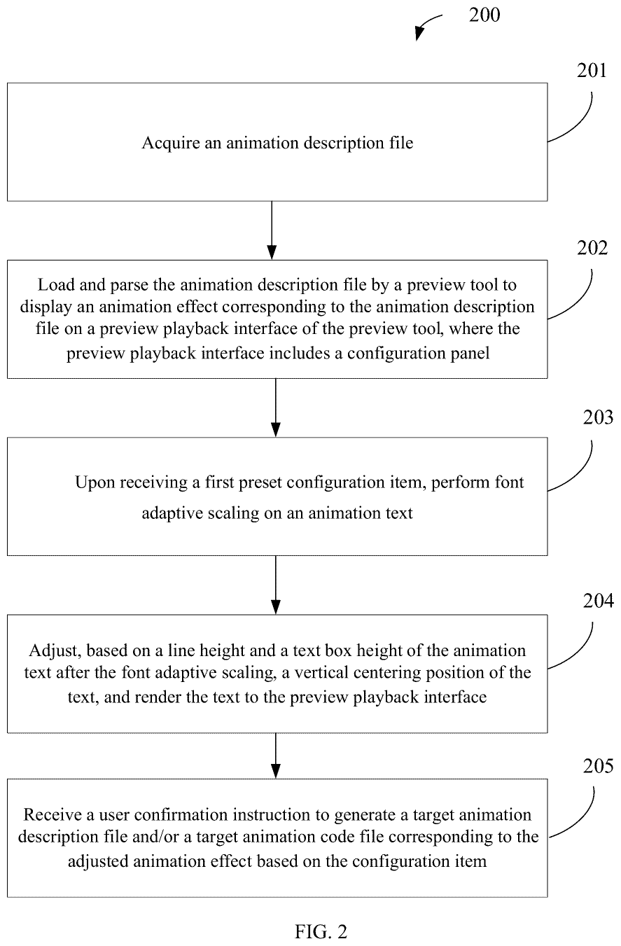

In some embodiments, referring to FIG. 2, an exemplary flowchart of a method 200 for animation development according to some embodiments of the present disclosure is shown. It will be appreciated that the method 200 is a specific implementation of the method 100 described above, and therefore, in this embodiment, the same steps in the method 200 as those in the method 100 are not repeated. Similarly, in any method provided below as a specific implementation of the method 100, the same steps as those of the method 100 are not repeated.

As shown in FIG. 2, the foregoing step S103 may include steps S203 and S204. Specifically, at step S203, the method 200 includes: upon receiving a first preset configuration item, performing font adaptive scaling on an animation text. In this embodiment, when the user triggers the first preset configuration item through the configuration panel, the preview tool may receive the first preset configuration item. It will be appreciated that other preset configuration items on the configuration panel are also triggered by the user through the configuration panel, and are not described in detail later. Upon receiving the first preset configuration item, the preview tool acquires the animation text selected by the user, and then performs font adaptive scaling on the animation text selected by the user. If the user does not select any animation text, font adaptive scaling is performed on all animation texts by default.

It will be appreciated that the animation text refers to the animated content presented by the animation effect. The preview tool of this embodiment is implemented based on Lottie-web so that font adaptive scaling of the animation text is implemented by a font adaptive scaling function provided by Lottie-web.

At step S204, the method 200 includes adjusting a vertical centering position of the text based on a line height and a text box height of the animation text after the font adaptive scaling, and then rendering the text to the preview playback interface. In this embodiment, after the font adaptive scaling on the animation text, a centered position of the animation text in a vertical direction is further adjusted so that the animation text remains centered in the vertical direction after the font adaptive scaling, and the animation text still has a good aesthetic effect after the font adaptive scaling.

As a specific implementation, assume that after the font adaptive scaling, the text box height is Y and the line height is H, then the centered position of the animation text in the vertical direction may be (Y−H/2).

Generally, step S103 in the method 100 for animation development is further described above in conjunction with FIG. 2. In the embodiments of the present disclosure, upon receiving a first preset configuration item, font adaptive scaling is performed on an animation text, and after the font adaptive scaling on the animation text, a centered position of the animation text in a vertical direction is re-adjusted based on a line height and a text box height of the animation text so that the animation text remains centered in the vertical direction after the font adaptive scaling, thereby ensuring a better aesthetic effect.

However, it should be understood by those skilled in the art that the above method is exemplary and not limiting, and that those skilled in the art may make adjustments as needed. Various embodiments of the method 100 according to some embodiments of the present disclosure and variations thereof will be further described below.

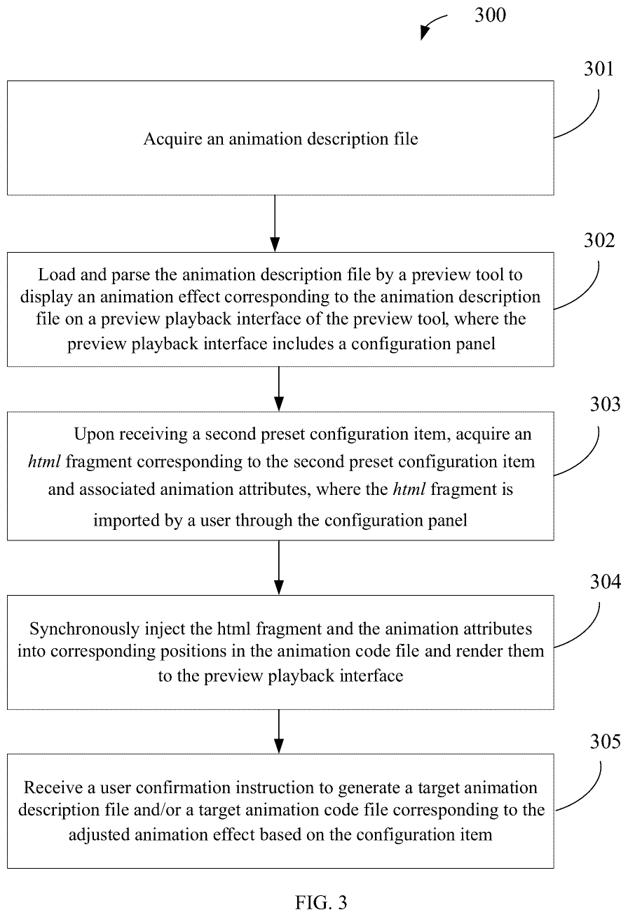

In some embodiments, referring to FIG. 3, an exemplary flowchart of a method 300 for animation development according to some embodiments of the present disclosure is shown. As shown in FIG. 3, step S103 may further include steps S303 to S304. First, at step S303, the method 300 includes: upon receiving a second preset configuration item, acquiring an html fragment corresponding to the second preset configuration item and an associated animation attributes, where the second preset configuration item on the configuration panel provides an html import entry. The user may import an html fragment from the html import corresponding to the second preset configuration item on the configuration panel. Through this entry, a developer can conveniently load and apply the relevant configuration to implement customization and adjustment of the interface elements without manual modification and debugging of the animation code file.

In this embodiment, the second preset configuration item is associated with a preset slot specification. The slot specification is defined by an animator or other personnel during animation production with the software adobe after effects. The slot specification includes animation attributes. Therefore, upon receiving the second preset configuration item, associated animation attributes may be obtained by identifying the slot specification associated with the second preset configuration item. It will be appreciated that the animation attribute refers to an attribute for controlling different dynamic features presented by the corresponding html element during the animation process. For example, the animation attributes may include, but is not limited to, a location, a transparency, a color change, a scaled size and the like of the html element.

The process then proceeds to step S304, where the method 300 includes synchronously injecting the html fragment and the animation attributes into corresponding positions in the animation code file and rendering them to the preview playback interface. In this manner, the html fragment and the animation attributes can be automatically and synchronously injected into the animation code file without the complexity of manual modification and repeated operation of the developer, thereby further improving the animation development efficiency.

Specifically, in this embodiment, a dom container separated from the svg canvas may be created to inject the html and the animation attribute into the dom container synchronously, which are then rendered to the preview playback interface.

Generally, step S103 in the method 100 for animation development is further described above in conjunction with FIG. 3. In the embodiments of the present disclosure, upon receiving a second preset configuration item, an html fragment imported through an html import entry corresponding to the second preset configuration item of the configuration panel by a user and animation attributes associated with the second preset configuration item are acquired, and then the html fragment and the animation attributes are synchronously injected into corresponding positions in the animation code file and rendering them to the preview playback interface, thereby achieving real-time adjustment of the animation effect without manual modification and debugging of the animation code file by the developer, and further improving the animation development efficiency.

However, it should be understood by those skilled in the art that the above method is exemplary and not limiting, and that those skilled in the art may make adjustments as needed. Various embodiments of the method 100 according to some embodiments of the present disclosure and variations thereof will be further described below.

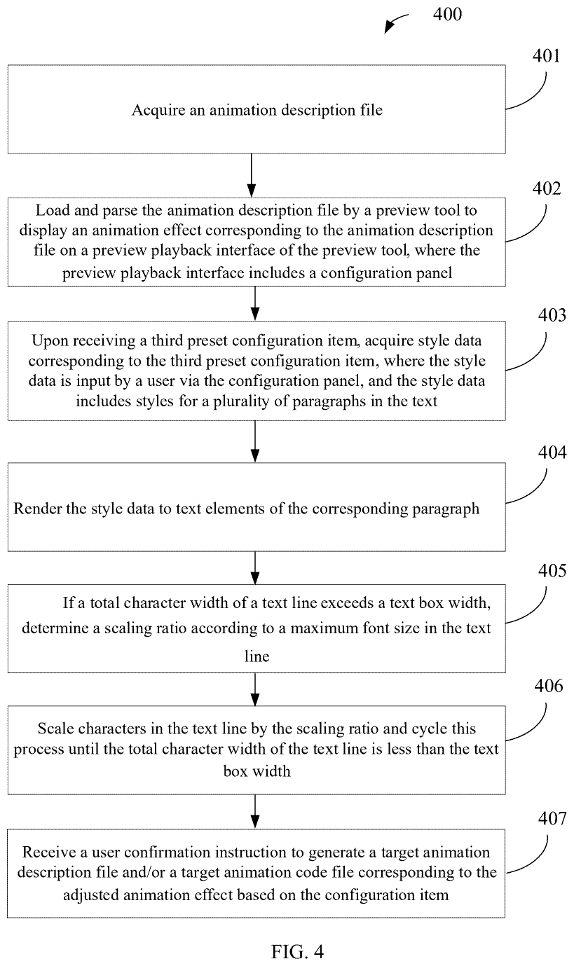

In some embodiments, referring to FIG. 4, an exemplary flowchart of a method 400 for animation development according to some embodiments of the present disclosure is shown. As shown in FIG. 4, step S103 may further include steps S403 and S404. At step S403, the method 400 includes: upon receiving a third preset configuration item, acquiring style data corresponding to the third preset configuration item, where the style data includes styles for a plurality of paragraphs in the text. In this embodiment, a developer or any other user inputs style data at a position corresponding to the third preset configuration item on the configuration panel, and associates and binds the style data with a corresponding paragraph of the animation text.

The third preset configuration item on the configuration panel may include adding an input parameter groupt at an original updateDocumentData interface of Lottie-web to split a text into multiple segments in the groupt, and provide an individual style receiving entry for each text segment for construction, so as to perform flexible style customization and construction.

Further at step S404, the method 400 includes rendering the style data to text elements of the corresponding paragraph. In this embodiment, the style data is rendered to text elements of the paragraph with which it is associated and bound. The text elements refer to text element nodes within the svg canvas, which may also be referred to as svg nodes.

In this embodiment, a developer or other users can modify the style of the animation text simply by inputting style data to a third preset configuration item on the configuration panel, and binding the style data with a corresponding paragraph of the animation text, and the adjusted animation effect can be viewed in real time, which saves manual modification and debugging of the animation code, and further improves the animation development efficiency.

In some embodiments, after step S404, the method may further include steps S405 and S406. At step S405, the method 400 includes: if a total character width of a text line is greater than a text box width, determining a scaling ratio according to a maximum font size within the text line. In some embodiments, the scaling ratio may be a reciprocal of the maximum font size. For example, if the maximum font size is F, then the scaling ratio is 1/F.

Then at step S406, the method 400 includes scaling characters in the text line by the scaling ratio and cycling this process until the total character width of the text line is less than the text box width. Specifically, characters in the text line are scaled down by the scaling ratio F−F*(1/F), and cycled until a width of all characters, i.e., the total character width, is less than the text box width. Through such an operation, overflowing or too large or too small characters can be avoided after the text style is modified, thereby ensuring a consistent display effect of the text in various devices and environments.

Generally, step S103 in the method 100 for animation development is further described above in conjunction with FIG. 4. In the embodiments of the present disclosure, upon receiving a third preset configuration item, style data of a plurality of paragraphs input by a user through the third preset configuration item on the configuration panel is acquired, and the style data is then rendered to text elements of the corresponding paragraph, thereby implementing style adjustment on the animation text, and further improving the animation development efficiency. Further after the style adjustment, if a total character width of a text line is detected to be greater than a text box width, characters in the text line are subjected to adaptive scaling to avoid overflowing or too large or too small characters after the text style is modified, thereby ensuring a consistent display effect of the text in various devices and environments.

However, it should be understood by those skilled in the art that the above method is exemplary and not limiting, and that those skilled in the art may make adjustments as needed. Various embodiments of the method 100 according to some embodiments of the present disclosure and variations thereof will be further described below.

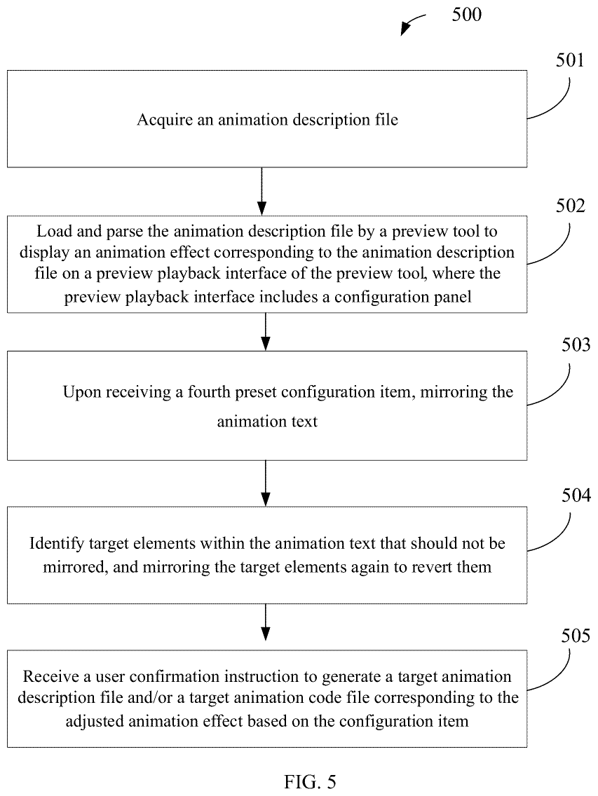

In some embodiments, different countries have different reading habits. For example, Chinese read from left to right, while people from the Middle East read from right to left. To adapt the animation effect to reading habits of different countries, in some embodiments, referring to FIG. 5, an exemplary flowchart of a method 500 for animation development according to some embodiments of the present disclosure is shown. As shown in FIG. 5, the step S103 described above may further include steps S503 and S504. Specifically, at step S503, the method 500 includes: upon receiving a fourth preset configuration item, mirroring the animation text. A user can implement mirroring of the animation text simply by triggering the fourth preset configuration item on the configuration panel, and enabling the preview tool to receive the fourth preset configuration item. For example, the user may click on a trigger icon of the fourth preset configuration item to trigger the fourth preset configuration item. The trigger icon may be a button or a link, which is not specifically limited in this embodiment. Then at step S504, the method 500 includes identifying target elements within the animation text that should not be mirrored, and mirroring the target elements again to revert them. Through such an operation, the animation text can be flipped to adapt to reading habits of different countries, so that the finally generated target description file and/or target animation code file can be suitable for different application scenarios.

As an example, to implement mirroring, the whole body may be flipped by adding transform:xcale(−1) to the animation container. When a target element, such as a text layer, which does not need to be mirrored is identified, the target element is flipped back by modifying the transform attribute. It will be appreciated that in Lottie-Web, the animation container is typically a designated DOM element in which a Lottie animation is rendered.

In some embodiments, after step S504, the method may further include modifying a rendering mode of the animation text to a mode of nested span within div for rendering, so as to provide context of a whole line of content for the text, and enable the browser to automatically adjust the word order.

It should be noted that as can be seen from the foregoing description, words of the animation text are rendered in a svg single character rendering mode when the word order is not adjusted. Therefore, during or after modifying the rendering mode of the animation text to the mode of nested span within div for rendering, DOM is further used for reproducing the function of rendering relying on other rendering modes otherwise, such as svg single character rendering.

Generally, step S103 in the method 100 for animation development is further described above in conjunction with FIG. 5. In the embodiments of the present disclosure, upon receiving a fourth preset configuration item, mirror flipping is performed on the animation text to enable a conversion of word orders to adapt to reading habits of different countries and markets, so that the finally generated target animation description file and/or target animation code file can be suitable for different application scenarios. However, it should be understood by those skilled in the art that the above method is exemplary and not limiting, and that those skilled in the art may make flexible adjustments as needed. Various embodiments of the method 100 according to some embodiments of the present disclosure and variations thereof will be further described below.

In some embodiments, the foregoing step S103 may further include: upon detecting that the animation text reaches a maximum number of lines, performing text adaptive scaling on the animation text, and rendering the text to the preview playback interface. Through such an operation, text overflow or occlusion can be avoided.

In some embodiments, a line number N where the current text is located is recorded during the text adaptive scaling, and then N is multiplied by the line height of the text to obtain and adjust positioning of the text in the vertical direction, so that the text remains centered in the vertical direction after the text adaptive scaling, and has a good aesthetic effect. In some embodiments, a fifth preset configuration item may be pre-configured on the configuration panel to set a maximum line breaks, thereby implementing flexible adjustments of the line breaks.

In some embodiments, the foregoing step S103 may further include: upon detecting a line break identifier, adding a line break to the animation text. The line break identifier may be \r.

Generally, step S103 in the method 100 for animation development is further described above. In the embodiments of the present disclosure, text adaptive scaling is performed on the animation text when the animation text reaches the maximum number of lines, to avoid text overflow or occlusion. However, it should be understood by those skilled in the art that the above method is exemplary and not limiting, and that those skilled in the art may make flexible adjustments as needed.

Therefore, the foregoing describes a method for animation development provided in the embodiments of the present disclosure, in which the animation effect is optimized by adjusting configuration items of a preview tool, and applying the generated target animation description file and/or target animation code file to a project, so that the animation development efficiency is improved, and the animation can be adapted to diversified application scenarios.

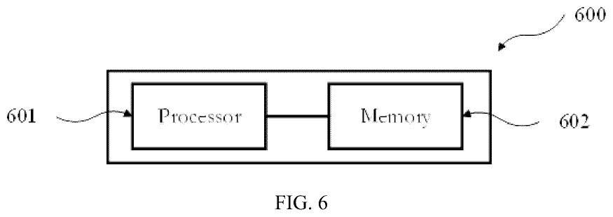

To implement the method steps of the present disclosure described above with reference to the drawings in a software and hardware level, an embodiment of the present disclosure further provides a processing apparatus, which is an electronic device as shown in FIG. 6. FIG. 6 shows an exemplary block diagram of an electronic device 600 according to an embodiment of the present disclosure. As shown in FIG. 6, the electronic device 600 of the present disclosure may include a processor 601 and a memory 602. The memory 602 stores thereon an executable program, which can be loaded and executed by the processor 601, so that the electronic device 600 implements any of the method steps described above.

In one example scenario, the memory 602 may be controlled by the processor 601. Further, the processor 601 may be a central processing unit (CPU), an application processor (AP), or the like, integrated in the electronic device 600; while as hardware for implementing a memory function, the memory 602 may be a read only memory (ROM), a dynamic RAM (DRAM), or the like.

The present disclosure may also be implemented as a non-transitory machine-readable storage medium having program instructions stored thereon which, when executed by the processor of the electronic device, cause the processor to perform at least some steps of any method of the present disclosure described above. In an embodiment of the present disclosure, there is further provided a computer program product including computer programs or instructions which, when executed by a processor, cause the method for animation development according to any embodiment of the present disclosure to be implemented.

Although various embodiments of the present disclosure have been shown and described herein, it will be obvious to those skilled in the art that such embodiments are provided by way of example only. Numerous modifications, changes, and substitutions may occur to those skilled in the art without departing from the spirit and scope of the present disclosure. It should be understood that various alternatives to the embodiments of the present disclosure described herein may be employed while practicing the present disclosure. It is intended that the following claims define the scope of the present disclosure and that equivalents or alternatives within the scope of these claims are covered thereby.

What is claimed is:

1. A method for animation development, comprising:
acquiring an animation description file;
loading and parsing the animation description file by a preview tool to display an animation effect corresponding to the animation description file on a preview playback interface of the preview tool, where the preview playback interface includes a configuration panel;
receiving a configuration item set by a user via the configuration panel and adjusting the animation effect in real time according to the configuration item; and
receiving a user confirmation instruction to generate a target animation description file and/or a target animation code file corresponding to the adjusted animation effect based on the configuration item.

2. The method of claim 1, wherein the preview tool is implemented based on Lottie-web.

3. The method of claim 1, wherein loading and parsing the animation description file by the preview tool to display the animation effect corresponding to the animation description file on the preview playback interface of the preview tool includes:
loading and parsing the animation description file by a preview tool to acquire an animation code file corresponding to the animation description file, wherein the preview tool loads the animation description file in an asynchronous loading mode; and
rendering the animation code file to display the corresponding animation effect on the preview playback interface.

4. The method of claim 1, wherein receiving the configuration item set by the user via the configuration panel and adjusting the animation effect in real time according to the configuration item includes:
upon receiving a first preset configuration item, performing font adaptive scaling on an animation text; and
adjusting a vertical centering position of the text based on a line height and a text box height of the animation text after the font adaptive scaling, and then rendering the text to the preview playback interface.

5. The method of claim 1, wherein receiving the configuration item set by the user via the configuration panel and adjusting the animation effect in real time according to the configuration item includes:
upon receiving a second preset configuration item, acquiring an html fragment corresponding to the second preset configuration item and associated animation attributes, wherein the html fragment is imported by a user via the configuration panel; and
synchronously injecting the html fragment and the animation attributes into corresponding positions in the animation code file and rendering them to the preview playback interface.

6. The method of claim 1, wherein receiving the configuration item set by the user via the configuration panel and adjusting the animation effect in real time according to the configuration item includes:
upon receiving a third preset configuration item, acquiring style data corresponding to the third preset configuration item, wherein the style data is input by a user via the configuration panel, and the style data includes styles of a plurality of paragraphs in the text; and
rendering the style data to text elements of the corresponding paragraph.

7. The method of claim 6, wherein after rendering the style data to text elements of the corresponding paragraph, the method includes:
if a total character width of a text line exceeds a text box width, determining a scaling ratio according to a maximum font size within the text line; and
scaling characters in the text line by the scaling ratio and cycling this process until the total character width of the text line is less than the text box width.

8. The method of claim 1, wherein receiving the configuration item set by the user via the configuration panel and adjusting the animation effect in real time according to the configuration item includes:
upon receiving a fourth preset configuration item, mirroring on the animation text; and
identifying target elements within the animation text that should not be mirrored, and mirroring the target elements again to revert them.

9. A processing apparatus for animation development, comprising:
a processor configured to execute program instructions; and
a memory configured to store the program instructions which, when loaded and executed by the processor, cause the processor to perform:
acquiring an animation description file;
loading and parsing the animation description file by a preview tool to display an animation effect corresponding to the animation description file on a preview playback interface of the preview tool, where the preview playback interface includes a configuration panel;
receiving a configuration item set by a user via the configuration panel and adjusting the animation effect in real time according to the configuration item; and
receiving a user confirmation instruction to generate a target animation description file and/or a target animation code file corresponding to the adjusted animation effect based on the configuration item.

10. The apparatus of claim 9, wherein the preview tool is implemented based on Lottie-web.

11. The apparatus of claim 9, wherein the processor is further configured to implement loading and parsing the animation description file by the preview tool to display the animation effect corresponding to the animation description file on the preview playback interface of the preview tool by:
loading and parsing the animation description file by a preview tool to acquire an animation code file corresponding to the animation description file, wherein the preview tool loads the animation description file in an asynchronous loading mode; and
rendering the animation code file to display the corresponding animation effect on the preview playback interface.

12. The apparatus of claim 9, wherein the processor is further configured to implement receiving the configuration item set by the user via the configuration panel and adjusting the animation effect in real time according to the configuration item by:
upon receiving a first preset configuration item, performing font adaptive scaling on an animation text; and
adjusting a vertical centering position of the text based on a line height and a text box height of the animation text after the font adaptive scaling, and then rendering the text to the preview playback interface.

13. The apparatus of claim 9, wherein the processor is further configured to implement receiving the configuration item set by the user via the configuration panel and adjusting the animation effect in real time according to the configuration item by:
upon receiving a second preset configuration item, acquiring an html fragment corresponding to the second preset configuration item and associated animation attributes, wherein the html fragment is imported by a user via the configuration panel; and
synchronously injecting the html fragment and the animation attributes into corresponding positions in the animation code file and rendering them to the preview playback interface.

14. The apparatus of claim 9, wherein the processor is further configured to implement receiving the configuration item set by the user via the configuration panel and adjusting the animation effect in real time according to the configuration item by:
upon receiving a third preset configuration item, acquiring style data corresponding to the third preset configuration item, wherein the style data is input by a user via the configuration panel, and the style data includes styles of a plurality of paragraphs in the text; and
rendering the style data to text elements of the corresponding paragraph.

15. The apparatus of claim 14, wherein the processor is further configured to implement, after rendering the style data to text elements of the corresponding paragraph:
if a total character width of a text line exceeds a text box width, determining a scaling ratio according to a maximum font size within the text line; and
scaling characters in the text line by the scaling ratio and cycling this process until the total character width of the text line is less than the text box width.

16. The apparatus of claim 9, wherein the processor is further configured to implement receiving the configuration item set by the user via the configuration panel and adjusting the animation effect in real time according to the configuration item by:
upon receiving a fourth preset configuration item, mirroring on the animation text; and
identifying target elements within the animation text that should not be mirrored, and mirroring the target elements again to revert them.

17. A non-transitory machine-readable storage medium having program instructions stored thereon, wherein the program instructions, when loaded and executed by a processor, cause the processor to perform:
acquiring an animation description file;
loading and parsing the animation description file by a preview tool to display an animation effect corresponding to the animation description file on a preview playback interface of the preview tool, where the preview playback interface includes a configuration panel;
receiving a configuration item set by a user via the configuration panel and adjusting the animation effect in real time according to the configuration item; and
receiving a user confirmation instruction to generate a target animation description file and/or a target animation code file corresponding to the adjusted animation effect based on the configuration item.
